(19) United States
(12) Patent Application Publication
(10) Pub. No.: US 2024/0233217 A1
(43) Pub. Date: Jul. 11, 2024

(54) CLASSIFIED DISPLAY SYSTEM AND CLASSIFIED DISPLAY METHOD OF CENTRALIZED MARKET ACTIVITY

(71) Applicant: Chih-Hung CHIU, Taoyuan City (TW)

(72) Inventor: Chih-Hung CHIU, Taoyuan City (TW)

(21) Appl. No.: 18/515,036

(22) Filed: Nov. 20, 2023

(30) Foreign Application Priority Data
Jan. 11, 2023 (TW) 112101247

(51) Int. Cl. G06T 11/20; G06Q 40/04

(52) U.S. Cl. CPC G06T 11/206; G06Q 40/04

(57) ABSTRACT

A classified display method of centralized market activity is disclosed and includes: obtaining a trading data; determining a current bid-ask price status; labeling a trading attribute for the trading data based on the bid-ask price status; deciding a displaying position of the trading data based on the trading attribute; identifying a trader identity based on a trading volume of the trading data; deciding a displaying pattern based on the trader identity; updating displaying data of an actual activity graph; and, updating a displaying figure of the actual activity graph.

### BACKGROUND OF THE DISCLOSURE

### Technical Field

The present disclosure relates to centralized market, and particularly to a classified display system and a classified display method used for classifying the activities of the centralized market and displaying the classified result.

### Description of Related Art

The current existing trading systems and trading software utilized in the centralized market present data through bar charts.

Please refer to FIG. 1, which is a schematic diagram showing a bar chart of related art. The bar chart 1 displays a vertical column to represent all the trading prices added up within a certain time period (such as 1 minute, 5 minutes, 10 minutes, or 1 hour, etc.). As disclosed in FIG. 1, the bar chart 1 shows a starting price 11 (i.e., the price of the first trading), an ending price 12 (i.e., the price of the last trading), the bottom price 13, and the ceiling price 14 in this time period. In the embodiment of FIG. 1, the left side of the bar chart 1 is labeled to represent the starting price 11 and the right side of the bar chart 1 is labeled to represent the ending price 12. In addition, another vertical column is presented below the bar chart 1 to show a total trading volume 10 of the trading that are completed in this time period.

Please refer to FIG. 2 as the same time, where FIG. 2 is a schematic diagram showing a candlestick chart of related art. In the centralized market of a part of the countries (such as Taiwan), the trading systems and the trading software utilize the candlestick chart (also called a k-chart) to show the trading information in a certain time period. Similar to the aforementioned bar chart 1, the candlestick chart 2 shows a starting price 21, an ending price 22, a bottom price 23, and a ceiling price 24 in this time period. If the starting price 21 is higher than the ending price 22, the thick part of the chart is presented by a first color (such as green); if the starting price 21 is lower than the ending price 22, the thick part of the chart is presented by a second color (such as red). By using the first color and the second color to show the trading information, the use can easily understand the activity trend in this time period.

As shown in FIG. 2, similar to the bar chart 1 of FIG. 1, another vertical column is presented below the candlestick chart 2 to show the total trading volume 20 of the trading that are completed within this time period. In some cases, the color of this vertical column is identical to the color of the thick part of the candlestick chart 2.

As discussed above, the bar chart 1 and the candlestick chart 2 utilized by the traditional trading systems and trading software can only show the trading prices and the trading volumes within the certain time periods; however, they cannot clearly indicate the actual volume dealt at each price within each time period. For example, both the bar chart 1 and the candlestick chart 2 show that 925 trading are completed between prices 1710˜1725 within a time period of 1 minute, but they are unable to show that how many trading are dealt at the price of 1710, how many trading are dealt at the price of 1711, and so on. In other words, both the bar chart 1 and the candlestick chart 2 lack the ability to show the deep meaning of the trading.

According to the above drawback, a novel display system and display method are required for the current centralized market, where the display system and the display method should be able to perform meaningful analysis and classification to the trading data and provide the result to the user for further assessment by an intuitive matter.

### SUMMARY OF THE DISCLOSURE

The present disclosure is directed to a classified display system and a classified display method of centralized market activity, which may clearly present specific information including the trading attribute, the trader identity, the price, and the advantages/disadvantages of the buyer and the seller, etc. within a certain time period.

In one of the exemplary embodiments, the classified display method includes:
a) obtaining a trading data by a classified display system from a trading system;
b) confirming a current bid-ask price status;
c) labeling a trading attribute for the trading data based on the bid-ask status;
d) deciding a displaying position of the trading data in an actual activity graph (AAG) based on the trading attribute;
e) identifying a trader identity corresponding to the trading data based on a trading volume of the trading data;
f) deciding a displaying pattern of the trading data in the AAG based on the trader identity;
g) after the step f), updating a displaying data of the AAG; and
h) after the step f), updating a displaying figure of the AAG.

In one of the exemplary embodiments, the classified display system includes:
a wireless transmission unit, configured to connect with a trading system, obtaining a trading data from the trading system in real-time;
a storing unit, configured to temporarily store the trading data;
a human machine interface, configured to set a time period;
a displaying unit, configured to display an actual activity graph (AAG) corresponding to the time period; and
a processor electrically connected with the wireless transmission unit, the storing unit, the human machine interface, and the displaying unit, configured to create the AAG based on the time period, compute a displaying data and draw a displaying figure of the AAG based on the trading data, and comprises:
a price monitoring module, configured to confirm a bid-ask price status when the trading data is completed;
a trading attribute labeling module, configured to label a trading attribute for the trading data based on the bid-ask price status and decide a displaying position of the trading data in the AAG based on the trading attribute;
a trader identity identifying module, configured to identify a trader identity corresponding to the trading data based on a trading volume of the trading data and decide a displaying pattern of the trading data in the AAG based on the trader identity;
a data computation module, configured to update the displaying data based on the trading data; and
a drawing module, configured to update the displaying figure based on the trading data.

In comparison with related art, the present disclosure presents more trading information that have deeper meanings through a single graph for the user to easily assess the current activity trend.

### BRIEF DESCRIPTION OF THE DRAWINGS

FIG. 1 is a schematic diagram showing a bar chart of related art.

FIG. 2 is a schematic diagram showing a candlestick chart of related art.

FIG. 3 is a schematic diagram showing an actual activity graph of the present disclosure according to a first embodiment.

FIG. 4 is a block diagram showing a classified display system of the present disclosure according to a first embodiment.

FIG. 5 is a flowchart of a classified display method of the present disclosure according to a first embodiment.

FIG. 6 is a schematic diagram showing an actual activity graph of the present disclosure according to a second embodiment.

FIG. 7A is a schematic diagram showing the trend of bar charts.

FIG. 7B is a schematic diagram showing the trend of the actual activity graphs of the present disclosure.

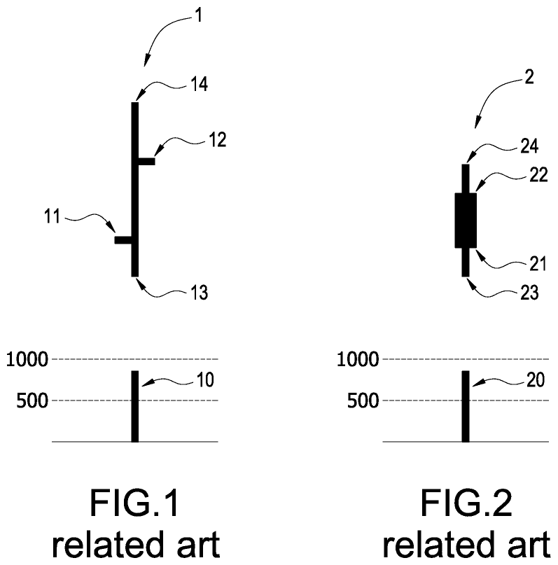

### DETAILED DESCRIPTION

In cooperation with the attached drawings, the technical contents and detailed description of the present disclosure are described hereinafter according to multiple embodiments, being not used to limit its executing scope. Any equivalent variation and modification made according to appended claims is all covered by the claims claimed by the present disclosure.

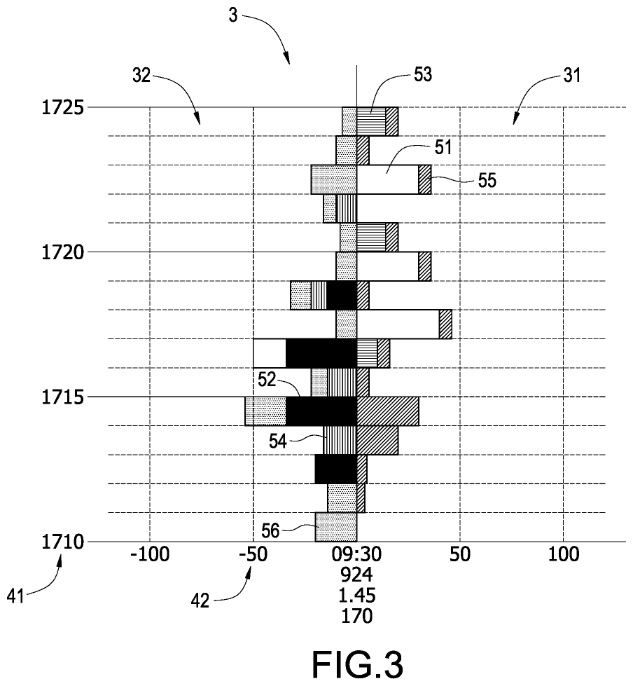

Please refer to FIG. 3, which is schematic diagram showing an actual activity graph of the present disclosure according to a first embodiment. The present disclosure provides a classified display system and classified display method of centralized market activity (referred to as the classified display system and the classified display method hereinafter). The present disclosure utilizes the classified display system and the classified display method to analyze and classify the real-time trading data to create an actual activity graph (AAG) as shown in FIG. 3.

In the present disclosure, one AAG 3 corresponds to a time period set by the user, such as 1 minute, 5 minutes, 10 minutes, or 1 hour, etc. The classified display system analyzes and classifies multiple records of the trading data within this time period to create an AAG 3 that belongs to this time period. In other words, the present disclosure generates multiple AAGs 3 for the entire trading time, where the time period set by the user is the frequency of creating the AAG 3. In an exemplary embodiment, the entire trading time of the centralized market is 4.5 hour. If the time period is set by the user to be 1 minute, the classified display system creates 270 AAGs 3 for the entire trading time, where each AAG 3 respectively represents a 1-minute time period.

As shown in FIG. 3, Y-axis of the AAG 3 represents a trading price 41 (1710-1725 (NTD) are taken as an example) and X-axis of the AAG 3 represents a trading volume 42. In addition, a time-based vertical base line is provided in the AAG 3 (i.e., the line aligned with time 09:30), where a buyer active area 31 and a seller active area 32 are respectively presented at two sides of the vertical base line. The technical feature of the present disclosure is that, if one trading data is classified by the classified display system as a buyer-active type trading, it will be displayed in the buyer active area 31 of the AAG 3. On the other hand, if one trading data is classified by the classified display system as a seller-active type trading, it will be displayed in the seller active area 32 of the AAG 3.

It should be mentioned that in the present disclosure, the classified display system further identifies the identity of the trader dealing each trading according to the trading volume of each trading data. Therefore, the classified trading system may further decide the displaying pattern for each trading data to be displayed in the AAG 3 based on the trader identity corresponding to each trading data. For example, multiple horizontal bars with different patterns are displayed in FIG. 3 to represent the trading data that are completed by different traders.

In the embodiment of FIG. 3, the displaying pattern includes a first displaying pattern 51 representing the trading data of the buyer-active type and dealt by a major player or a big player, a second displaying pattern 52 representing the trading data of the seller-active type and dealt by the major player or the big player, a third displaying pattern 53 representing the trading data of the buyer-active type and dealt by a middle player, a fourth displaying pattern 54 representing the trading data of the seller-active type and dealt by the middle player, a fifth displaying pattern 55 representing the trading data of the buyer-active type and dealt by an individual player, and a sixth displaying pattern 56 representing the trading data of the seller-active type and dealt by the individual player.

In the embodiment of FIG. 3, the first displaying pattern 51, the second displaying pattern 52, the third displaying pattern 53, the fourth displaying pattern 54, the fifth displaying pattern 55, and the sixth displaying pattern 56 are respectively displayed by different styles, such as a blank pattern, a filled pattern, a horizontal line pattern, a vertical line pattern, a diagonal line pattern, and a dashed line pattern.

In another embodiment, the first displaying pattern 51, the second displaying pattern 52, the third displaying pattern 53, the fourth displaying pattern 54, the fifth displaying pattern 55, and the sixth displaying pattern 56 are respectively displayed in different colors. For example, the first displaying pattern 51 may be displayed in red, the second displaying pattern 52 may be displayed in blue, the third displaying pattern 53 may be displayed in pink, the fourth displaying pattern 54 may be displayed in green, the fifth displaying pattern 55 may be displayed in cyan, and the sixth displaying pattern 56 may be displayed in grey. However, the above descriptions are only few embodiments of the present disclosure, but it is not limited thereto.

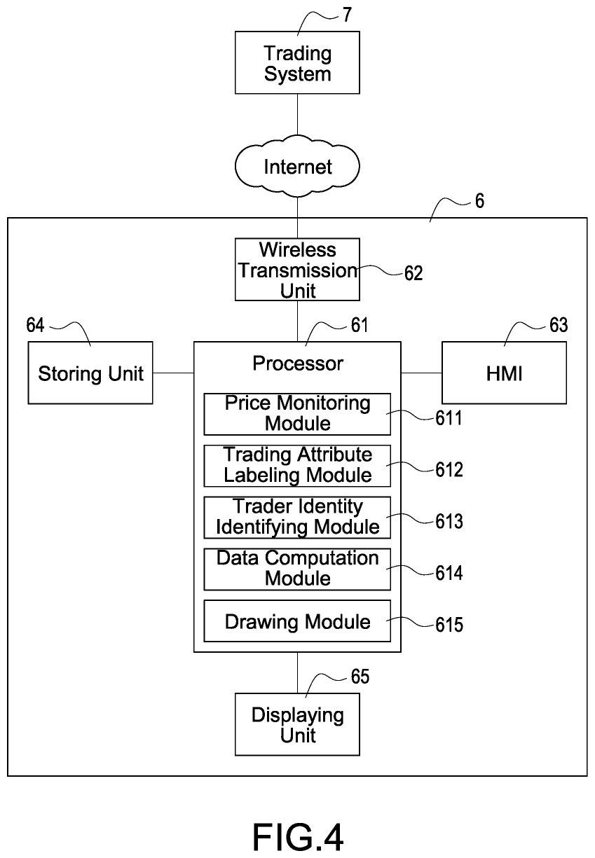

Please refer to FIG. 3 and FIG. 4 at the same time, wherein FIG. 4 is a block diagram showing a classified display system of the present disclosure according to a first embodiment. The classified displaying system 6 of the present disclosure connects with a trading system 7 of the centralized market (such as the stock market) through the Internet to obtains, in real-time, every single trading data that is electronic matched successfully through the trading system 7, so as to create the AAG 3 as shown in FIG. 3 based on these obtained trading data.

As shown in FIG. 4, the classified display system 6 includes a processor 61, a wireless transmission unit 62, a human-machine interface (HMI) 63, a storing unit 64, and a displaying unit 65, wherein the processor 61 is electrically connected with the wireless transmission unit 62, the HMI 63, the storing unit 64, and the displaying unit 65.

In one of the exemplary embodiments, the classified display system 6 may be implemented by an electronic device such as a server, an industrial computer, a personal computer, a laptop, or an intelligent mobile device, etc. in accompanying with peripheral apparatuses and application program(s). The application program records computer executable program codes. When the classified display system 6 executes the application program, the computer executable program codes are executed to perform the classified display method of the present disclosure.

The wireless transmission unit 62 may be, for example but not limited to, a Wi-Fi module, a 4G module, a 5G module, or a Bluetooth module, etc. The classified display system 6 establishes a connection with the trading system 7 through the wireless transmission unit 62, so as to continuously obtain every single trading data that is traded in real-time from the trading system 7 during the available trading time. In one of the exemplary embodiments, each trading data respectively include the trading time, the trading price, and the trading volume of this trading, but not limited thereto.

The storing unit 64 may be, for example but not limited to, a memory, a hard-drive disk, a CD player, or a register, etc. The classified display system 6 temporarily stores the trading data received from the trading system 7 in the storing unit 64.

In one of the exemplary embodiments, the classified display system 6 stores the aforementioned application program (not shown in the FIGs) in the storing unit 64. The classified display system 6 executes the application program after being activated to implement the classified display method of the present disclosure through the execution of the application program.

In one of the exemplary embodiments, the classified display system 6 stores a crawler program (not shown in the FIGs) in the storing unit 64. The classified display system 6 executes the crawler program to monitor a real-time information source (such as the trading system 7), so as to grab the current activity information from the real-time information source to the classified display system 6 by way of live data streaming.

Therefore, the classified display system 6 may create the AAGs 3 of the present disclosure in an order based on the continuously received information. In other words, the classified display system 6 utilizes the crawler program as the entry program of obtaining the real-time data.

The HMI 63 may be, for example but not limited to, a keyboard, a mouse, or a voice input device, etc. The user may use the HMI 63 to operate the classified display system 6 in order to set the required time period (such as 1 minute, 5 minutes, or 10 minutes, etc.). The classified display system 6 creates the AAG 3 correspondingly based on the time period set by the user.

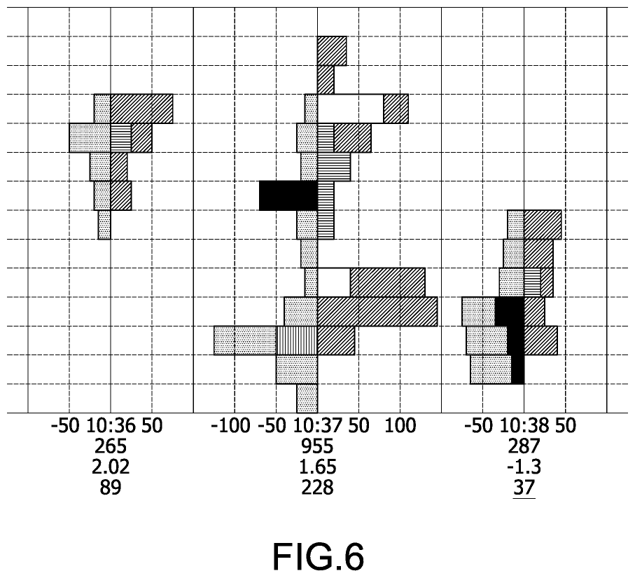

After one or more AAGs 3 are created, the classified display system 6 displays the one or more AAGs 3 through the displaying unit 65. In one of the exemplary embodiments, the classified display system 6 displays multiple AAGs 3 in a side-by-side manner (as shown in FIG. 6). Therefore, the user may understand the current activity trend of the centralized market based on the multiple AAGs 3 continuously created by the classified display system 6 and further predominate deeply the long-short status of the current market.

The processor 61 may be, for example but not limited to, a central process unit (CPU), a micro control unit (MCU), a programmable logic controller (PLC), or a system on chip (SoC), etc. In the present disclosure, the processor 61 creates a corresponding AAG 3 in according to the time period set by the user, computes the displaying data of the AAG 3, and draws the displaying graph of the AAG 3 based on the multiple trading data obtained from the trading system 7 (detailed described in the following).

As shown in FIG. 4, the processor 61 includes a price monitoring module 611, a trading attribute labeling module 612, a trader identity identifying module 613, a data computation module 614, and a drawing module 615. In one of the exemplary embodiments, the modules 611-615 are hardware modules implemented in the processor 61. In another embodiment, the processor 61 executes the application program to virtually create the aforementioned modules 611-615 based on the functions implemented by the application program, which means the modules 611-615 are software modules. However, the above descriptions are only few embodiments of the present disclosure, but not limited thereto.

When the classified display system 6 obtains one trading data, the price monitoring module 611 is utilized to confirm the bid-ask price status of this trading data when this trading is completed. The trading attribute labeling module 612 labels a trading attribute for this trading data based on the current bit-ask price status and then decides the displaying position of this trading data in the AAG 3 based on the trading attribute of this trading data.

More specifically, the current centralized market that utilizes electronic matching of trading not only provides the trading price and the trading volume of every single trading in real-time, but also publics a target bid price and a target bid volume as well as a target ask price and a target ask volume in real-time. For example, if the trading price of a trading is 1715 (NTD), the current target bid price of this trading is 1715 (NTD), and the current target ask price of this trading is 1716 (NTD), it means that a buyer wants to buy at price of 1715 (NTD) while a seller wants to sell at price of 1716 (NTD). The above bid-ask price status is also called sell and buy in the centralized market of a part of countries. In the present disclosure, the price monitoring module 611 is utilized to monitor the bid-ask price status that includes the target bid price, the target bid volume, the target ask price, and the target ask volume while one trading data is completed.

According to the above description, if the trading price of next trading is 1715 (NTD), it means that the seller agrees to sell at price of 1715 (NTD) which is lower than the target ask price to the buyer who is waiting to buy at price of 1715 (NTD). In the present disclosure, the trading attribute labeling module 612 determines that this trading belongs to a seller-active type trading and labels the trading data with a trading attribute of seller active. On the other hand, if the trading price of next trading is 1716 (NTD), it means that the buyer agrees to buy at price of 1716 (NTD) which is higher than the target bid price from the seller who is waiting to sell at price of 1716 (NTD). In the present disclosure, the trading attribute labeling module 612 determines that this trading belongs to a buyer-active type trading and labels the trading data with a trading attribute of buyer active.

As mentioned above, the trading attribute labeled by the trading attribute labeling module 612 includes a label of buyer active and a label of seller active. When a trading data is completed at the target bid price, the trading attribute labeling module 612 labels this trading data with a trading attribute of seller active; when a trading data is completed at the target ask price, the trading attribute labeling module 612 labels this trading data with a trading attribute of buyer active.

By labeling a corresponding trading attribute for every trading data within the time period, the user may easily know the prices and the volumes that the buyer-active buying activities occurred (such as the buyer-active area 31 as shown in FIG. 3). Also, the user may easily know the prices and the volumes that the seller-active selling activities occurred (such as the seller-active area 32 as shown in FIG. 3).

In the present disclosure, the trading attribute labeling module 612 dynamically decides the trading attribute of the trading data based on the bid-ask price status while the trading is completed. For example, the target bid price is changed to 1716 (NTD) and the target ask price is changed to 1717 (NTD), if the trading price of next trading is 1716 (NTD), the trading attribute labeling module 612 may determine that this trading belongs to a seller-active type trading and label the trading attribute of seller active for the trading data of this trading. In other words, same trading price occurs repeatedly doesn't mean the market activity has not changed. By using the AAG 3 of the present disclosure, the user may easily observe the variation of the buyer's biding intention as well as the seller's asking intention, so as to understand the attitude changing of both the long side and the short side.

It should be mentioned that the participants of the centralized market (including the buyer and the seller) respectively have different backgrounds (i.e., have different qualities), which can be classified into the major player, the big player, the middle player, and the individual player, etc. The major player and the big player have the largest trading volume, the middle player has the middle trading volume, and the individual player has the smallest trading volume. Due to different identifies of the traders, each trading respectively provides different meanings to the market.

In the present disclosure, the trader identity identifying module 613 identities the trader identity of one trading data based on the trading volume of this trading data. The trader identity may be, for example but not limited to, a first type of trader (the major player or the big player), a second type of trader (the middle player), or a third type of trader (the individual player). After identifying the trader identity of one trading data, the trader identity identifying module 613 further decides the displaying pattern of this trading data in the AAG 3 based on the trader identity of this trading data.

In one of the exemplary embodiments, the trader identity identifying module 613 identifies the trader identity of one trading data as the major player or the big player when the trading volume of this trading data is greater than a first value (such as 20 units), identifies the trader identity of this trading data as the individual player when the trading volume of this trading data is smaller than a second value (such as 10 units), and identifies the trader identity of this trading data as the middle player when the trading volume of this trading data is between the first value and the second value.

However, the above description is only one of the exemplary embodiments of the present disclosure, the classified display system 6 of the present disclosure may classify the trader identity into four, five, or more than five types based on the trading volume, the trader identity is not limited to the above three types.

By labeling the trading data through the trading attribute labeling module 612, the classified display system 6 knows the trading attribute of the trading data (which belongs to a buyer-active type trading or a seller-active type trading). By identifying the trader identity of the trading data through the trader identity identifying module 613, the classified display system 6 knows the type of the trader (the major player/big player, the middle player, or the individual player) who completed the trading corresponding to this trading data.

For example, if the target bid price is 1716 (NTD), the target ask price is 1717 (NTD), and a trading data is generated with a trading price of 1717 (NTD) and a trading volume of 20 units, the classified display system 6 may determine that this trading is completed by the major player or the big player who acts as the buyer and actively buys the units from the seller. This buyer-active type trading indicates a high biding intention of the buyer. In sum, the classified display system 6 may effectively classify every single trading data being obtained.

For another example, if the target bid price is 1716 (NTD), the target ask price is 1717 (NTD), and a trading data is generated with a trading price of 1716 (NTD) and a trading volume of 2 units, the classified display system 6 may determine that this trading is completed by the individual player who acts as the seller and actively sells the units to the buyer. This seller-active type trading indicates a high asking intention of the seller.

Please refer back to FIG. 4. The data computation module 614 continuously updates the displaying data of the AAG 3 based on the trading data obtained by the classified display system 6. In particularly, the data computation module 614 of the present disclosure updates the displaying data of the current AAG 3 based on the trading attribute and the trading volume of every trading data. In the embodiment of FIG. 3, the displaying data at least includes the total trading volume, the ratio of a first trading volume of buyer-active trading and a second trading volume of seller-active trading, and the difference between the first trading volume of buyer-active trading and the second trading volume of seller-active trading within the time period. However, the above description is only one of the exemplary embodiments, but not limited thereto.

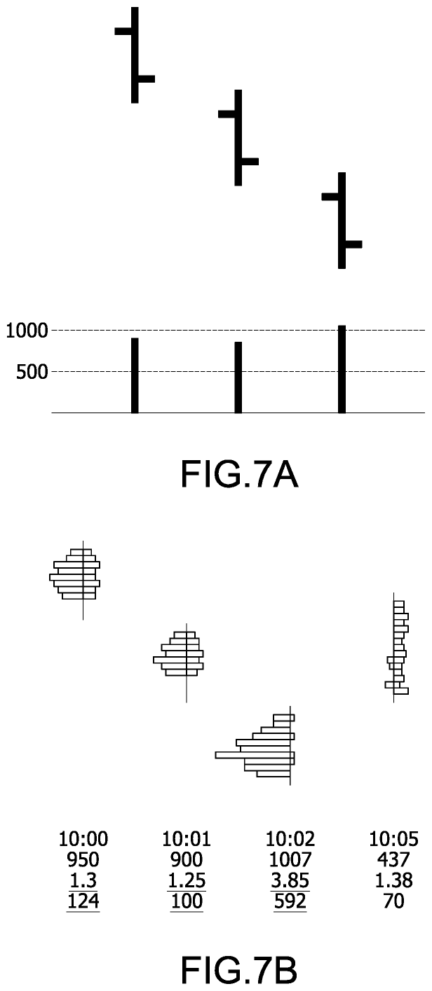

As shown in FIG. 3, each AAG 3 displays, below the vertical base line, the current time period (such as 09:30 in FIG. 3) and the data computed based on the multiple trading data obtained within the time period. In the embodiment of FIG. 3, the total trading volume of the buyer-active type trading and the seller-active type trading combined is 924 units, wherein the trading volume of the buyer-active type trading is 1.45 times more than that of the seller-active type trading, and the active buying volume is 170 units more than the active selling volume (i.e., the net advantage amount of the buyer is 170 units) In the embodiment of FIG. 3, the trading volume of active buying trading is more than that of the active selling trading, so that the displaying data (including 1.45 and 170) is shown as positive numbers. In other embodiment, if the trading volume of active selling trading is more than that of the active buying trading, the displaying data may be shown with a negative sign, a bottom line, or other recognizable text or symbol (such as the example shown in FIG. 7B).

Please refer back to FIG. 4, the drawing module 615 continuously updates the displaying figure of the AAG 3 based on the trading data obtained by the classified display system 6.

As discussed above, the AAG 3 of the present disclosure includes the buyer active area 31 at one side (such as the right side) of the vertical base line and the seller active area 32 at another side (such as the left side) of the vertical base line. In the embodiment, the drawing module 615 draws and updates the displaying figure in the buyer active area 31 based on the multiple trading data labelled with the trading attribute of buyer active, and draws and updates the displaying figure in the seller active area 32 based on the multiple trading data labelled with the trading attribute of seller active.

As shown in FIG. 3, the displaying figure of AAG 3 includes multiple horizontal bars sorted according to the prices, wherein each horizontal bar respectively represents the trading volume (corresponding to the length of the bar) of a specific type of trader (corresponding to the pattern of the bar) at a specific price (corresponding to the height of the bar). In the present disclosure, the drawing module 615 adjusts the length of one of the multiple horizontal bars based on the displaying position and displaying pattern of one trading data decided by the processor 61 after the classified display system 6 obtains this trading data.

In the embodiment of FIG. 3, the user may understand, through the AAG 3, that the market activity shocks between the bottom price of 1710 (NTD) and the ceiling price of 1725 (NTD) within the time period (such as 1 minute starting from 09:30) with the total trading volume of 924 units, and the user may also understand the price and the volume of active buying by a first type of trader (such as the major player or the big player), the price and the volume of active selling by the first type of trader, the price and the volume of active buying by a second type of trader (such as the middle player), the price and the volume of active selling by the second type of trader, the price and the volume of active buying by a third type of trader (such as the individual player), the price and the volume of active selling by the third type of trader, the ratio of the trading volume of active buying and the trading volume of active selling, and the difference between the trading volume of active buying and the trading volume of active selling, etc. Therefore, the AAG 3 is convenient for the user to predominate the upcoming market activity.

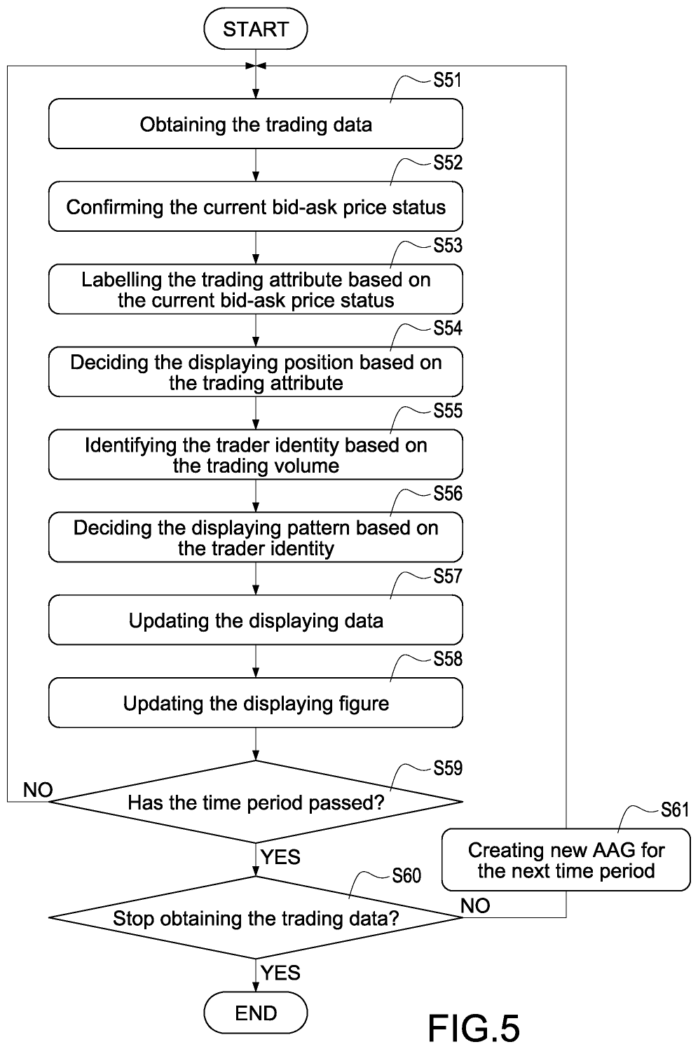

Please refer to FIG. 3, FIG. 4, and FIG. 5 at the same time, wherein FIG. 5 is a flowchart of a classified display method of the present disclosure according to a first embodiment. FIG. 5 discloses the detailed steps of the classified display method of the present disclosure, wherein the classified display method is incorporated with the classified display system 6 as shown in FIG. 4, but not limited thereto.

After being activated and connected with the trading system 7, the classified display system 6 obtains a trading data in real-time from the trading system 7 (step S51), and the classified display system 6 confirms the current bid-ask price status of the centralized market while obtaining the trading data (step S52). Next, the classified display system 6 labels a trading attribute for this trading data based on the current bid-ask price status (step S53). In particularly, the classified display system 6 labels the trading attribute of seller active for this trading data if the trading price occurs at the target bid price and labels the trading attribute of buyer active for this trading data if the trading price occurs at the target ask price.

Next, the classified display system 6 decides the displaying position of this trading data in the AAG 3 based on the trading attribute labeled in the step S53 (step S54). More specifically, if the trading data is labeled with the trading attribute of buyer active, the classified display system 6 displays this trading data in the buyer active area 31 of the AAG 3; if the trading data is labeled with the trading attribute of seller active, the classified display system 6 displays this trading data in the seller active area 32 of the AAG 3;

After the step S54, the classified display system 6 further identifies the trader identity corresponding to this trading data based on the trading volume of this trading data (step S55), and further decides the displaying pattern of this trading data in the AAG 3 based on the trader identity (step S56).

In one of the exemplary embodiments, the classified display system 6 identifies the trader identity of one trading data as the major player or the big player if the trading volume of this trading data is greater than or equal to a first value. Therefore, the classified display system 6 sets a first displaying pattern for the trading data that is completed by the major player or the big player with the trading attribute of buyer active and sets a second displaying pattern for the trading data that is completed by the major player or the big player with the trading attribute of seller active.

In one of the exemplary embodiments, the classified display system 6 identifies the trader identity of one trading data as the middle player if the trading volume of this trading data is smaller than the first value and is greater than or equal to a second value. Therefore, the classified display system 6 sets a third displaying pattern for the trading data that is completed by the middle player with the trading attribute of buyer active and sets a fourth displaying pattern for the trading data that is completed by the middle player with the trading attribute of seller active.

In one of the exemplary embodiments, the classified display system 6 identifies the trader identity of one trading data as the individual player if the trading volume of this trading data is smaller than the second value. Therefore, the classified display system 6 sets a fifth displaying pattern for the trading data that is completed by the individual player with the trading attribute of buyer active, and sets a sixth displaying pattern for the trading data that is completed by the individual player with the trading attribute of seller active. In the embodiment, the first to the sixth displaying patterns are all different, such as represented in different colors, by different figures, or by different symbols.

Next, the classified display system 6 updates the displaying data corresponding to this trading data on the AAG 3 (step S57) and updates the displaying figure corresponding to this trading data on the AAG 3 (step S58).

More specifically, in the step S57, the classified display system 6 updates the displaying data on the AAG 3 according to the trading attribute and trading volume of this trading data, wherein the displaying data at least includes the total trading volume, the ratio of the trading volume corresponding to buyer-active type trading and the trading volume corresponding to seller-active type trading, and the difference of the trading volume corresponding to buyer-active type trading and the trading volume corresponding to seller-active type trading within this time period. In addition, in the step S58, the classified display system 6 adjusts the length of one of the multiple horizontal bars on the AAG 3 according to the displaying position and the displaying pattern of this trading data.

In the present disclosure, the classified display system 6 continuously performs the step S51 through the step S58 after being activated and continuously determines whether the current time period is passed (step S59). In other words, the classified display system 6 determines whether to update the current AAG 3 based on the obtained trading data or to create another AAG 3 for the next time period.

As mentioned above, the classified display system 6 of the present disclosure accepts the operation from the user to set the required time period through the HMI 63 and respectively creates the corresponding AAG 3 for each time period. Therefore, if the current time period (such as 1 minute or 5 minutes, etc.) has not yet passed, the classified display system 6 re-executes the step S51 through the step S58 based on same AAG 3 and continuously updates the displaying data and the display figure of this AAG 3.

If the current time period is determined to be passed, the classified display system 6 first determines whether to stop obtaining new trading data (step S60). For example, the classified display system 6 stops obtaining new trading data if the trading time has ended or the connection between the classified display system 6 and the trading system 7 fails. In this case, the classified display system 6 stops updating the AAG 3 and terminates the classified display method of the present disclosure.

If the classified display system 6 continuously obtains new trading data, it may create a new AAG 3 for the next time period (step S61). Next, the classified display system 6 re-executes the step S51 through the step S58 based on the new AAG 3 of the next time period and continuously updates the displaying data and the displaying figure of the new AAG 3 based on the trading data obtained next.

As mentioned above, the AAG 3 created by the classified display system 6 and the classified display method of the present disclosure may directly and clearly provide the bottom price and the ceiling price, the total trading volume, and the active buying/active selling status of each type of trader at each price within a certain time period. However, only one AAG may not enough for the user to directly and effectively predominate the activity trend of the market.

Please refer to FIG. 6 at the same time, wherein FIG. 6 is a schematic diagram showing an actual activity graph of the present disclosure according to a second embodiment. As shown in FIG. 6, after the market activity moves for a while (such as 30 minutes or 1 hour, etc.), the classified display system 6 creates multiple AAGs 3 based on user's setting, thereby the user may observe the activity trend based on the information provided in these AAGs 3. FIG. 6 show three AAGs 3 within 3 minutes, but the classified display system 3 is not limited to the disclosure of FIG. 6.

For example, when the market activity moves to a price approximate to that at a half hour ago, the user may compare multiple AAGs 3 to determine the actions made by each type of traders at same or similar prices as well as the variation (increasing/decreasing) in the degrees of the enthusiastic of reaction. Therefore, it is easier for the user to tell the intention increasing or decreasing of the trader as a buyer, so as to effectively assess the following activity trend.

Please refer to FIG. 7A and FIG. 7B, wherein FIG. 7A is a schematic diagram showing the trend of bar charts and FIG. 7B is a schematic diagram showing the trend of the actual activity graphs of the present disclosure. The following description takes traditional bar charts to be compared with the AAGs of the present disclosure to describe the technical effect brought by the AAG.

As shown in FIG. 7A, when observing a continuous falling activity trend via the traditional bar charts, the three vertical bars maintain a huge trading volume while the ending price of each time period occurred at a position extremely close to the bottom price. Based on the aforementioned information, the user may only know the falling activity trend is strong and continued. In comparison with the bar charts, the AAGs provided by the present disclosure enables the user to deeply understand the actual status of the current market.

In the embodiment of FIG. 7B, it is obvious that a fierce fighting between the buyers and the sellers occurred between the time period of 10:00 and the time period of 10:01, after that the advantage was taken by the sellers (the trading volume of seller-active type trading is greater than the trading volume of buyer-active type trading) while the buyer gets weak and is unable to maintain the target bid price.

Next, during the time period of 10:02, in addition to observing the trading price keeps falling and the trading volume keeps increasing, it can also be clearly seen from the AAG that almost no buyer-active type trading occurs (i.e., the bars shown at right side of the AAG) while a bunch of seller-active type trading is completed. Therefore, the user may determine that the continued active selling pressure from the seller is absorbed by the passive waiting buy order. In sum, the user may determine that the case belongs to a signal showing the “selling at low prices” situation, which means the trading belongs the old sell case instead of new sell case, and the buyer who passively completes the trading should be active in new buy case.

Further, during the time period of 10:05, it can be clearly seen that the total trading volume is 437 units and the buyer's advantage ratio is 1.38 times, the trading volume of the buyer is 70 units more than the trading volume of the seller, and the market price has almost recovered. In the meantime, the user may determine that 746 units of active seller advantage volume (124+100+592-70) has been accumulated during this falling-recovering trend, which means 746 units of waiting buy orders were passively completed via being touched by the active sell orders.

Based on the signal provided by the AAGs, the user may see that the buyer can recover the market price to the price that started to fall by only 70 units of buyer advantage volume. Also, the seller lacking positive attitude while the price falls shows that the sell orders while the price falls are old sell cases. In order words, the sell orders are selling activity of the seller for avoiding loss expansion. If the market tries to challenge the known bottom price, it must be, within the price period of the 746 units that the buyer is actively willing to buy, (1) the buyer's willingness of participating the trading is obviously declining or disappears, or (2) the seller shows more active selling activities.

As mentioned above, the AAG of the present disclosure clearly shows who (i.e., the major player, the big player, the middle player, or the individual player), what (bid or ask), when (the time period), where (the trading price), and how (the interaction between the major player and the big player, the interaction between the major player/the big player and the middle player, or the interaction between the major player/the big player and the individual player), so that the user may infer why (i.e., to observe the motivation, the purpose, the intention, or even the emotional state of the trading activity completed by each type of traders).

As the skilled person will appreciate, various changes and modifications can be made to the described embodiment. It is intended to include all such variations, modifications and equivalents which fall within the scope of the present disclosure, as defined in the accompanying claims.

What is claimed is:

1. A classified display method of centralized market activity, incorporated with a classified display system, and the classified display method comprising:
a) obtaining a trading data by the classified display system from a trading system;
b) confirming a current bid-ask price status;
c) labeling a trading attribute for the trading data based on the bid-ask status;
d) deciding a displaying position of the trading data in an actual activity graph (AAG) based on the trading attribute;
e) identifying a trader identity corresponding to the trading data based on a trading volume of the trading data;
f) deciding a displaying pattern of the trading data in the AAG based on the trader identity;
g) after the step f), updating a displaying data of the AAG; and
h) after the step f), updating a displaying figure of the AAG.

2. The classified display method in claim 1, further comprising:
i) re-executing the step a) to the step h) until a time period corresponding to the AAG passes;
j) creating another AAG for next time period after the time period corresponding to the AAG has passed; and
k) after the step j), re-executing the step a) to the step i) based on the another AAG of the next time period.

3. The classified display method in claim 2, wherein the bid-ask price status comprises a target bid price, a target bid volume, a target ask price, and a target ask volume.

4. The classified display method in claim 3, wherein the trading attribute comprises buyer active and seller active, and the step c) comprises labeling the trading attribute of seller active for the trading data when the trading data is completed at the target bid price and labeling the trading attribute of buyer active for the trading data when the trading data is completed at the target ask price.

5. The classified display method in claim 4, wherein the displaying position comprises a buyer active area at one side of the AAC and a seller active area at another side of the AAC, and the step d) comprises displaying the trading data with the trading attribute of buyer active at the buyer active area and displaying the trading data with the trading attribute of seller active at the seller active area.

6. The classified display method in claim 5, wherein the step e) comprises identifying the trader identity as a major player or a big player when the trading volume is greater than or equal to a first value, identifying the trader identity as an individual player when the trading volume is smaller than a second value, and identifying the trader identity as a middle player when the trading volume is between the first value and the second value.

7. The classified display method in claim 6, wherein the step f) comprises setting a first displaying pattern for the trading data when the trading data is completed by the major player or the big player and has the trading attribute of buyer active, setting a second displaying pattern for the trading data when the trading data is completed by the major player or the big player and has the trading attribute of seller active, setting a third displaying pattern for the trading data when the trading data is completed by the middle player and has the trading attribute of buyer active, setting a fourth displaying pattern for the trading data when the trading data is completed by the middle player and has the trading attribute of seller active, setting a fifth displaying pattern for the trading data when the trading data is completed by the individual player and has the trading attribute of buyer active, and setting a sixth displaying pattern for the trading data when the trading data is completed by the individual player and has the trading attribute of seller active.

8. The classified display method in claim 7, wherein the first displaying pattern, the second displaying pattern, the third displaying pattern, the fourth displaying pattern, the fifth displaying pattern, and the sixth displaying pattern are displayed in different colors.

9. The classified display method in claim 7, wherein the step g) comprises updating the displaying data based on the trading attribute and the trading volume of the trading data, wherein the displaying data at least comprises a total trading volume within the time period, a ratio of the trading volume of a buyer-active type trading and the trading volume of a seller-active type trading, and a difference between the trading volume of the buyer-active type trading and the trading volume of the seller-active type trading.

10. The classified display method in claim 7, wherein the displaying figure comprises multiple horizontal bars sorted in according to prices, and the step f) comprises adjusting the length of one of the multiple horizontal bars in the AAC based on the displaying position and the displaying pattern of the trading data.

11. A classified display system of centralized market activity, connected with a trading system through the Internet, and comprising:
a wireless transmission unit, configured to connect with the trading system, obtaining a trading data from the trading system in real-time;
a storing unit, configured to temporarily store the trading data;
a human machine interface, configured to set a time period;
a displaying unit, configured to display an actual activity graph (AAG) corresponding to the time period; and
a processor electrically connected with the wireless transmission unit, the storing unit, the human machine interface, and the displaying unit, configured to create the AAG based on the time period, compute a displaying data and draw a displaying figure of the AAG based on the trading data, and comprises:
a price monitoring module, configured to confirm a bid-ask price status when the trading data is completed;
a trading attribute labeling module, configured to label a trading attribute for the trading data based on the bid-ask price status and decide a displaying position of the trading data in the AAG based on the trading attribute;
a trader identity identifying module, configured to identify a trader identity corresponding to the trading data based on a trading volume of the trading data and decide a displaying pattern of the trading data in the AAG based on the trader identity;
a data computation module, configured to update the displaying data based on the trading data; and
a drawing module, configured to update the displaying figure based on the trading data.

12. The classified display system in claim 11, wherein the processor is configured to continuously obtain the trading data from the trading system and update the displaying data and the displaying figure of the AAG until the time period passes, and create another AAG for next time period after the time period has passed.

13. The classified display system in claim 12, wherein the bid-ask price status comprises a target bid price, a target bid volume, a target ask price, and a target ask volume.

14. The classified display system in claim 13, wherein the trading attribute comprises buyer active and seller active, and the trading attribute labeling module is configured to label the trading attribute of seller active for the trading data when the trading data is completed at the target bid price and label the trading attribute of buyer active for the trading data when the trading data is completed at the target ask price.

15. The classified display system in claim 14, wherein the displaying position comprises a buyer active area at one side of the AAC and a seller active area at another side of the AAC, and the processor is configured to display the trading data with the trading attribute of buyer active at the buyer active area and display the trading data with the trading attribute of seller active at the seller active area.

16. The classified display system in claim 15, wherein the trader identity identifying module is configured to identify the trader identity as a major player or a big player when the trading volume is greater than or equal to a first value, identify the trader identity as an individual player when the trading volume is smaller than a second value, and identify the trader identity as a middle player when the trading volume is between the first value and the second value.

17. The classified display system in claim 16, wherein the processor is configured to set a first displaying pattern for the trading data when the trading data is completed by the major player or the big player and has the trading attribute of buyer active, set a second displaying pattern for the trading data when the trading data is completed by the major player or the big player and has the trading attribute of seller active, set a third displaying pattern for the trading data when the trading data is completed by the middle player and has the trading attribute of buyer active, set a fourth displaying pattern for the trading data when the trading data is completed by the middle player and has the trading attribute of seller active, set a fifth displaying pattern for the trading data when the trading data is completed by the individual player and has the trading attribute of buyer active, and set a sixth displaying pattern for the trading data when the trading data is completed by the individual player and has the trading attribute of seller active.

18. The classified display system in claim 17, wherein the first displaying pattern, the second displaying pattern, the third displaying pattern, the fourth displaying pattern, the fifth displaying pattern, and the sixth displaying pattern are displayed in different colors.

19. The classified display system in claim 17, wherein the data computation module is configured to update the displaying data based on the trading attribute and the trading volume of the trading data, wherein the displaying data at least comprises a total trading volume within the time period, a ratio of the trading volume of a buyer-active type trading and the trading volume of a seller-active type trading, and a difference between the trading volume of the buyer-active type trading and the trading volume of the seller-active type trading.

20. The classified display system in claim 17, wherein the displaying figure comprises multiple horizontal bars sorted in according to prices, and the drawing module is configured to adjust the length of one of the multiple horizontal bars in the AAC based on the displaying position and the displaying pattern of the trading data.
